(19) United States
(12) Patent Application Publication
(10) Pub. No.: US 2004/0162394 A1
(43) Pub. Date: Aug. 19, 2004

(54) Hot melt thermoplastic elastomer composition and articles including same

(76) Inventors: William L. Bunnelle, Ham Lake, MN (US); Andres I. Sustic, Woodbury, MN (US)

Correspondence Address: Sean D. Solberg, DORSEY & WHITNEY LLP, Intellectual Property Department, 50 South Sixth Street, Suite 1500, Minneapolis, MN, 55402-1498, US

(21) Appl. No.: 10/680,550

(22) Filed: Oct. 7, 2003

Related U.S. Application Data
(60) Provisional application No. 60/416,680, filed on Oct. 7, 2002.

(51) Int. Cl. C08F 295/00; B32B 27/00

(52) U.S. Cl. 525/271; 428/500

(57) ABSTRACT

The present invention includes methods and compositions relating to a hot melt thermoplastic elastomer composition that includes a block copolymer, a tackifying agent, and a plasticizer.

### CROSS-REFERENCE TO RELATED APPLICATION(S)

The present application claims priority to U.S. provisional patent application 60/416,680, filed Oct. 7, 2002, which is incorporated herein by reference.

### FIELD OF THE INVENTION

The present invention relates to a hot melt thermoplastic elastomeric composition including a block copolymer, a tackifying agent, and a plasticizer. The present invention further relates to the use of the elastomeric composition to impart elasticity and stretchability to laminates. In addition, the present invention relates to the use of the elastomeric composition to make a three-dimensional interlocking web for use in laminates.

### BACKGROUND OF THE INVENTION

Various nonwovens have been incorporated into laminates useful for garments or garment like materials. These laminates can include, for example, side panels, waist bands, cuffs, topsheets, backsheets, bandages, wraps or wound dressings. Additionally, nonwovens have been used in combination with absorbent materials to form items such as pull-on diapers, training pants, disposable diapers with fasteners, feminine napkins, pantiliners or incontinence garments.

Generally, the laminate is created by adhering the nonwoven to the underlying substrate, such as an absorbent material, by use of an adhesive. Often it is desirable for the garment to have some stretchability or elasticity in combination, optionally, with the absorbent material. Thus, the laminate formed with the nonwoven typically has at least five layers: a top nonwoven, adhesive, a stretchable/elastic material or elastomer, adhesive, and a bottom nonwoven. The adhesive is typically required to adhere the top nonwoven, the elastomer, and the bottom nonwoven.

There are several disadvantages related to the existing technology. For example, the viscosities of the existing elastomer materials create the need for expensive application equipment and further create the likelihood that the substrate materials will be damaged during application of the elastomer. The viscosities of the existing elastomer materials typically fall within the range of between about 150,000 milliPascal seconds (“mPa.s”), or centipoise (“cps”), to over 1,000,000 mPa.s at above 350° F. These high viscosity levels ensure that the elastomers cannot be applied with standard hot melt adhesive equipment, thus necessitating the use of expensive special elastomer application equipment, thus increasing the expense and unreliability of the process. Further, the viscosity levels of the existing elastomers make it necessary to apply the elastomer to the nonwoven at a temperature exceeding 350° F., well above the melting temperature of the nonwoven. This results in loss of product or deformation in the product. As a result, the cost of the overall product is increased.

In a further disadvantage, the existing technology typically requires adhesives. The existing elastomers are extrusion processed into a film which is subsequently required to be adhered with adhesive to the nonwoven or fabric. Thus, the process requires two sets of equipment to produce the article: adhesive application equipment and the special elastomer application equipment discussed above. This increases costs significantly. In addition, extrusion coating techniques are used which further increases the cost of the final article.

Another disadvantage of the existing technology is the resulting product. The existing technology results in a stretchable laminate containing nonwoven material having elasticity or stretchability in only one direction. That is, the laminate can be elongated in one direction (along one axis) but cannot be elongated significantly in the transverse direction (along the axis 90 degrees to the first axis).

A need therefore exists for an elastomeric composition with a lower application viscosity and lower working temperatures for the application process that requires only one set of inexpensive hot melt composition application equipment and that imparts elasticity to a laminate in both directions while eliminating the need for use of an adhesive to join the nonwoven layers together.

### BRIEF SUMMARY OF THE INVENTION

The present invention, in one embodiment, is a hot melt thermoplastic elastomer composition. The composition has from about 35% by weight to about 70% by weight of a block copolymer formed from at least two blocks, a first block comprising at least one monoalkenyl arene and a second block comprising at least one conjugated diene. The composition also has from about 5% by weight to about 30% by weight of a tackifying agent and from about 15% by weight to about 45% by weight of a plasticizer. Further, the composition has a viscosity of from about 75,000 mPa.s (or cps) to about 5,000 mPa.s (or cps) at a temperature of about 350° F.

In an alternative embodiment, the present invention is a laminate comprising a first substrate and a hot melt thermoplastic elastomer composition associated with the substrate. The composition has a viscosity of from about 75,000 mPa.s to about 5,000 mPa.s at a temperature of about 350° F. The composition also has from about 35% by weight to about 70% by weight of a block copolymer formed from at least two blocks. In addition, the composition has from about 5% by weight to about 30% by weight of a tackifying agent, and from about 15% by weight to about 45% by weight of a plasticizer.

The present invention, in a further embodiment, is a method of extruding a hot melt thermoplastic composition comprising providing a hot melt thermoplastic elastomer composition and extruding the composition with a spiral spraying action such that filaments of the composition overlap and intercross with each other to create a three-dimensional interlocking web. The composition has a viscosity of from about 75,000 mPa.s to about 5,000 mPa.s at a temperature of about 350° F. Further, the composition has from about 35% by weight to about 70% by weight of a block copolymer formed from at least two blocks. In addition, the composition has from about 5% by weight to about 30% by weight of a tackifying agent, and from about 15% by weight to about 45% by weight of a plasticizer.

In another embodiment, the present invention is an interlocking hot melt thermoplastic elastomer web comprising overlapping and intercrossing filaments of a hot melt thermoplastic elastomer composition. The composition has a viscosity of from about 75,000 mPa.s to about 5,000 mPa.s at a temperature of about 350° F. Further, the composition has from about 35% by weight to about 70% by weight of a block copolymer formed from at least two blocks. In addition, the composition has from about 5% by weight to about 30% by weight of a tackifying agent, and from about 15% by weight to about 45% by weight of a plasticizer. Additionally, the web can be elongated in both a machine direction and a transverse direction.

Other features of the invention will be apparent from the following description of the preferred embodiments thereof, and from the claims. While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a graphical representation of the range of suitable elastomeric storage moduli (G′), according to one embodiment of the present invention.

FIG. 2 is a graphical representation of the Dahlquist criteria and of one elastomeric composition of the invention having a shear storage modulus greater than the Dahlquist requirements.

FIG. 3 is the nonwoven elastomeric composition prepared in accordance with the present invention in Example 1 and recovery tested at 100% elongation.

FIG. 4 is data upon which FIG. 3 is based.

FIG. 5 is the nonwoven elastomeric composition prepared in accordance with the present invention in Example 1 and recovery tested at 150% elongation.

FIG. 6 is data upon which FIG. 5 is based.

FIG. 7 is based upon a commercially available sample of HUGGIES SUPREME™ that was recovery tested at 100% elongation.

FIG. 8 is data upon which FIG. 7 is based.

FIG. 9 is based upon a commercially available sample of HUGGIES SUPREME™ that was recovery tested at 150% elongation.

FIG. 10 is data upon which FIG. 7 is based.

FIG. 11 is based upon a commercially available sample of PAMPERS CUSTOM FIT™ that was recovery tested at 100% elongation.

FIG. 12 is data upon which FIG. 11 is based.

FIG. 13 is based upon a commercially available sample of PAMPERS CUSTOM FIT™ that was recovery tested at 150% elongation.

FIG. 14 is data upon which FIG. 13 is based.

FIG. 15 is a graphical representation of the range of elastomeric storage moduli (G′) for three embodiments of the present invention.

FIG. 16 is a graphical representation of the range of elastomeric storage moduli (G′) for three embodiments of the present invention.

FIG. 17 is the nonwoven elastomeric composition of Example 1 spiral sprayed into a three dimensional (“3D”) web in accordance with one embodiment of the present invention and recovery tested at 140% elongation in the machine direction.

FIG. 18 is data upon which FIG. 17 is based.

FIG. 19 is the nonwoven elastomeric composition of Example 1 spiral sprayed into a 3D web in accordance with one embodiment of the present invention and recovery tested at 140% elongation in the tranverse direction.

FIG. 20 is data upon which FIG. 19 is based.

FIG. 21 is an image of a 3D web according to one embodiment of the present invention.

### DETAILED DESCRIPTION

The features and other details of the invention will now be more particularly described and pointed out in the claims. It will be understood that the particular embodiments of the invention are shown by way of illustration and not as limitations of the invention. The principle features of this invention can be employed in various embodiments without departing from the scope of the invention.

The term “comprising” means that the various components, ingredient, or steps can be conjointly employed in practicing the present invention. Accordingly, the term “comprising” encompasses the more restrictive terms “consisting of” and “consisting essentially of”.

The methods and compositions of the present invention are directed to an elastomeric composition for use in providing elasticity and stretchability to laminates. The compositions of the present invention exhibit a lower application viscosity that provides significant application advantages in comparison to existing technology. The lower viscosity allows for application of the compositions of the present invention using a broader range of application equipment, including standard hot melt adhesive equipment, and a broader range of application methods, than the existing technology. Further, the lower viscosity allows for application of the compositions of the present invention at a lower temperature than the application temperature of the existing technology, thus allowing application without melting or otherwise damaging the nonwoven components or other components of the laminate substrate. The compositions of the present invention further exhibit adhesive qualities that eliminate the need for an adhesive in order to adhere the nonwoven layers of the laminate. The methods of application of the present invention are directed to creating a three-dimensional interlocking web for use in laminates, wherein the web imparts elasticity allowing for elongation in both directions along the plane of the laminate.

In accordance with one embodiment, the present invention is a composition including a block copolymer, a tackifying agent, and a plasticizer.

The block copolymer, according to one embodiment, is present in the elastomeric composition in an amount from about 35% by weight to about 80% by weight of the composition. Alternatively, the block copolymer is present in an amount from about 40% by weight to about 65% by weight. In a further alternative, the block copolymer is present in an amount from about 45% by weight to about 60% by weight of the composition.

In one embodiment, the block copolymer is formed from at least two block portions. According to one aspect of the invention, one block portion is a thermoplastic block and another block portion is an elastomeric block. The term “thermoplastic” is recognized in the art and is intended to include those materials which can be melted and resolidified with little or no change in physical properties (assuming a minimum of oxidative degradation). The terms “elastic,” “elastomer,” or “elastomeric” are recognized in the art and pertain to materials that are capable of being elongated or deformed under an externally applied force, and which will substantially resume their original dimension or shape, sustaining only small permanent set (typically no more than about 20%), after the external force is released.

In accordance with one aspect of the invention, the thermoplastic (or “hard”) block portion is derived from materials which have a sufficiently high glass transition temperature to form crystalline or glassy domains at their use temperature. The “use temperature” is the temperature at which the composition is typically used. Generally, the use temperature is the ambient temperature. Further, because some embodiments are used in clothing, the human body temperature is considered a use temperature. These hard blocks generally form strong physical entanglements or agglomerates with other hard blocks in the copolymers. According to one embodiment, the hard block portion comprises from about 10% to about 80%, alternatively from about 20% to about 50%, and in a further alternative from about 35% to about 45% of the total weight of the copolymer.

In one embodiment, the hard block portion can be a monoalkenyl arene such as styrene, α-methyl styrene, other styrene derivatives, or mixtures thereof. Alternatively, the hard block portion can also be a copolymer derived from styrenic monomers such as those described hereinabove and olefinic monomers such as ethylenes, propylenes, butylenes, isoprenes, butadienes, and mixtures thereof. In a further alternative, the hard block portion is polystyrene. According to one embodiment, the polystyrene has a number-average molecular weight from about 1,000 Daltons (“D”) to about 200,000 D, alternatively from about 2,000 D to about 100,000 D, and in a further alternative from about 5,000 D to about 60,000 D. In one particular embodiment, polystyrene is present in an amount of about 44% of the total weight of the copolymer.

According to one embodiment, the elastomeric (or “soft”) block portion has a sufficiently low glass transition temperature at the use temperature of the polymer such that crystalline or glassy domains are not formed at these use temperatures. The number-average molecular weight of the soft block is typically from about 1,000 D to about 300,000 D, alternatively from about 10,000 D to about 200,000 D, and in a further alternative from about 20,000 D to about 100,000 D. According to one embodiment, the soft block portion comprises from about 20% to about 90% of the total weight of the copolymer, alternatively from about 50% to about 80%, and in a further alternative from about 65% to about 75% of the total weight of the copolymer.

According to one embodiment, the soft block portion is an olefinic polymer derived from conjugated aliphatic diene monomers of from about 4 to about 6 carbon atoms or linear alkene monomers of from about 2 to about 6 carbon atoms. Suitable diene monomers include butadiene, isoprene, and the like. Suitable alkene monomers include ethylene, propylene, butylene, and the like. In accordance with one embodiment, the soft block portion can include a substantially amorphous polyolefin such as ethylene/propylene polymers, ethylene/butylene polymers, polyisoprene, polybutadiene, and the like or mixtures thereof. In one aspect, the soft block portion is present in an amount of about 56% of the total weight of the copolymer and is polybutadiene.

The block copolymers in the compositions of the present invention are thermoplastic because they can be melted above the endblock's Tg, formed, and resolidified several times with little or no change in physical properties (assuming a minimum of oxidative degradation). Further, the block copolymers in the compositions are elastomeric since they form a three-dimensional physical structure below the glass transition temperature (Tg) of the thermoplastic block portion. This provides that the copolymers exhibit elastic memories in response to external forces.

According to one embodiment, the block copolymer of the present invention is a linear triblock copolymer having the structure A-B-A, wherein A represents a hard block and B represents a soft block. In accordance with one aspect of the present invention, triblock copolymers include styrene-olefin-styrene copolymers such as styrene-butadiene-styrene (S-B-S), styrene-ethylene/butylene-styrene (S-EB-S), styrene-ethylene/propylene-styrene (S-EP-S), styrene-isoprene-styrene (S-I-S), hydrogenated polystyrene-isoprene/butadiene-styrene (S-IB-S) and mixtures thereof. Commercial embodiments include the Kraton® D and Kraton® G series block copolymers, available from Kraton Polymers, LLC (700 Milam, North Tower, 13th Floor, Houston, Tex. 77002), Europene® Sol T block copolymers available from EniChem (Houston, Tex.), Vector® block copolymers available from Exxon (Dexco) (Houston, Tex.), Solprene® block copolymers from Housmex® (Houston, Tex.) as well as others.

Alternatively, the composition of the present invention comprises A-B diblock copolymers, A-B-A triblock copolymers, A-B-A-B tetrablock copolymers, A-B-A-B-A pentablock copolymers, (A-B)ₙ radial block copolymers, or the like. Alternatively, the structures can be branched or grafted versions of the above.

According to one embodiment, the composition of the present invention comprises only one type of block copolymer. Alternatively, the composition comprises a blend of block copolymers. In a further alternative, the composition is a blend of one or more block copolymers with one or more other substantially less elastomeric polymers such as polypropylene, polyethylene, polybutadiene, polyisoprene, or mixtures thereof. In one aspect of the invention, the block copolymers employed preferably only have minor quantities of other polymers present. Alternatively, the composition has essentially no other such polymers present. According to one embodiment, the composition comprises triblock copolymers including no greater than 30% diblock, alternatively no more than 10% diblock, and in a further alternative, the composition comprises 100% triblock copolymer.

In accordance with one embodiment of the present invention, the tackifying agent in the elastomeric composition is present in an amount from about 5% by weight to about 30% by weight of the composition. Alternatively, the tackifying agent is present in an amount from about 10% by weight to about 25% by weight. In a further alternative, the tackifying agent is present in an amount from about 12% by weight to about 20% by weight of the composition.

The term “tackifying agent” is recognized in the art and is intended to include those substances that provide tack to the composition which serves to secure elements to be bonded while the composition sets, and reduces the viscosity of the composition, making the composition easier to apply to the substrate. The tackifying agent can be, but is not limited to, rosin, dehydrogenated rosin, polyterpene resins, hydrogenated rosin esters of glycerol, hydrogenated rosin esters of pentaerythritol, coumarone-indene resins, hydrogenated rosin, esters of polymerized rosin and glycerol, maleic anhydride modified rosin and rosin derivatives, partial esters of styrene maleic acid copolymers, chlorinated biphenyls, oil-soluble phenol aldehyde resins and combinations thereof. Alternatively, the tackifying agent is derived from renewable resources such as rosin derivatives including wood rosin, tall oil, gum rosin as well as rosin esters and natural and synthetic terpenes, and derivatives of such. Aliphatic, aromatic or mixed aromatic-aliphatic petroleum based tackifiers are also useful in the elastomeric compositions of the present invention. Representative examples of useful hydrocarbon resins include alpha-methyl styrene resins, branched and unbranched C₅ resins, C₉, resins, dicyclopentadiene (DCPD) based resins, as well as styrenic and hydrogenated modifications of such. Tackifying agents range from being a liquid at about 25° C. (room temperature) to having a ring and ball softening point up to about 150° C. The tackifier or tackifier mixture according to one embodiment has a softening point of greater than about 80° C. Alternatively, the tackifying agent has a softening point of about 100° C. or higher.

The plasticizer, according to one embodiment of the present invention, is present in the elastomeric composition in an amount from about 15% by weight to about 45% by weight of the composition. Alternatively, the plasticizer is present in an amount from about 20% by weight to about 40% by weight. In a further alternative, the plasticizer is present in an amount from about 25% by weight to about 35% by weight of the composition.

The term “plasticizer” is recognized in the art and is intended to include those materials that generally help to plasticize a material, such as the elastomeric compositions of the invention. According to one embodiment, the plasticizer is an oil. Suitable examples of oil(s) useful in the elastomeric compositions of the invention include oils which are primarily hydrocarbon oils which are low in aromatic content and which are paraffinic or naphthenic in character. The oils are most useful when they have low volatility, are transparent and have as little color and odor as possible. The use of the oils in the invention also contemplates the use of liquid resins, olefin oligomers, liquid elastomers, low molecular weight polymers, vegetable oils and other natural oils as well as white mineral oil. Alternatively, the plasticizer is any known material for plasticizing a polymeric composition.

Alternatively, the compositions of the present invention include additional ingredients such as an antioxidant. According to one embodiment, the antioxidant is present in the composition in an amount of from about 0.1% to about 5% by weight of the composition. Alternatively, the antioxidant is present in an amount of from about 0.1% to about 2%. In a further alternative, the antioxidant is present in an amount of from about 0.1% to about 1% by weight of the composition. Suitable antioxidants include butylated hydroxy toluene, hindered phenolic antioxidants such as IRGANOX 1076 and IRGANOX 1010 (available from Ciba-Geigy), secondary amine antioxidants such as NAUGARD 445 (Uniroyal), VANOX (RT Vanderbilt) and OCTAMINE (Uniroyal). In accordance with one embodiment of the present invention, the antioxidant is a mixture of approximately equal parts by weight of a hindered phenolic antioxidant, (IRGANOX 1076 or IRGANOX 1010) and a secondary amine antioxidant (NAUGARD 445). Further useful antioxidants include, e.g., IRGANOX 1010. Further additional ingredients can include, without limitation, phosphite stabilizers such as WESTON 619 (Borg-Warner), optical brighteners such as UVITEX OB (Ciba-Geigy) and UV stabilizers such as TINUVIN (Ciba-Geigy).

Advantageously, the elastomeric compositions, in accordance with one embodiment of the present invention, exhibit a viscosity of from about 75,000 mPa.s (or cps) to about 5,000 mPa.s (or cps) at a temperature of about 350° F. Alternatively, the compositions exhibit a viscosity of from about 60,000 mPa.s (or cps) to about 7,500 mPa.s (or cps) at about 350° F. In a further alternative, the compositions exhibit a viscosity of from about 40,000 mPa.s (or cps) to about 10,000 mPa.s (or cps) at about 350° F. In one particular embodiment, the elastomeric composition has a viscosity of about 40,000 mPa.s at about 300° F. In another embodiment, the elastomeric composition has a viscosity of about 30,000 mPa.s at about 325° F. In still another embodiment, the elastomeric composition has a viscosity of about 17,500 mPa.s at about 350° F. Embodiments of the present invention are not limited to any particular temperature. Given the direct relationship between temperature and viscosity, one of ordinary skill in the art would understand that the above viscosities will vary as the temperature varies.

In contrast to the disadvantages of the existing technology as described above, the compositions of the present invention advantageously exhibit viscosities as described above that are suitable for application using standard application techniques and machinery and can be applied to synthetic polymer substrates without melting the substrate. The elastomeric compositions of the present invention can be used with coating machines commercially produced by Nordson, YUW Dynatech, Accumeter Division of May Coating or Robatech. The coating techniques employed include, for example, melt blowing, extrusion slot, slot die coating, “porous” coat, starved slot extrusion or controlled fiberization (“spiral” or “swirl” spray) or the methods described in U.S. Pat. No. 5,827,252 and 6,120,887, which are owned by H. B. Fuller and are incorporated herein by reference in their entirety; all methods known by the skilled artisan.

According to one embodiment, certain compositions of the present invention are not pressure sensitive adhesives (PSAs). That is, the storage modulus of the elastomeric compositions is greater than the commonly accepted Dahlquist criteria. The term “Dahlquist criteria” is recognized in the art and refers to the shear storage modulus as performed in tensile compliance and described in Dahlquist, C.A. Proc. Nottingham Conf. On Adhesion III, 134, 1966. For example, in accordance with one aspect of the present invention, the compositions have a shear storage modulus (G′) of greater than about 3×10⁶ dynes/cm² over a temperature range of from about 0° C. to about 60° C.

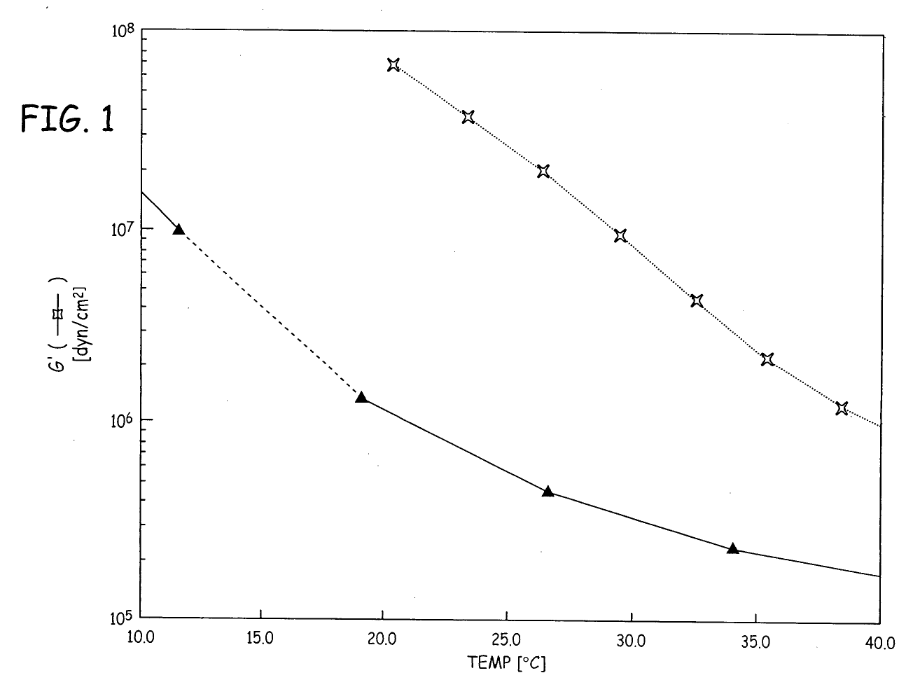

Alternatively, certain compositions of the present invention are PSAs. That is, the compositions have a shear storage modulus (G′) of less than about 3×10⁶ dynes/cm². In a further alternative, the elastomeric compositions have a storage modulus (G′) which falls within the shaded region as defined by FIG. 1.

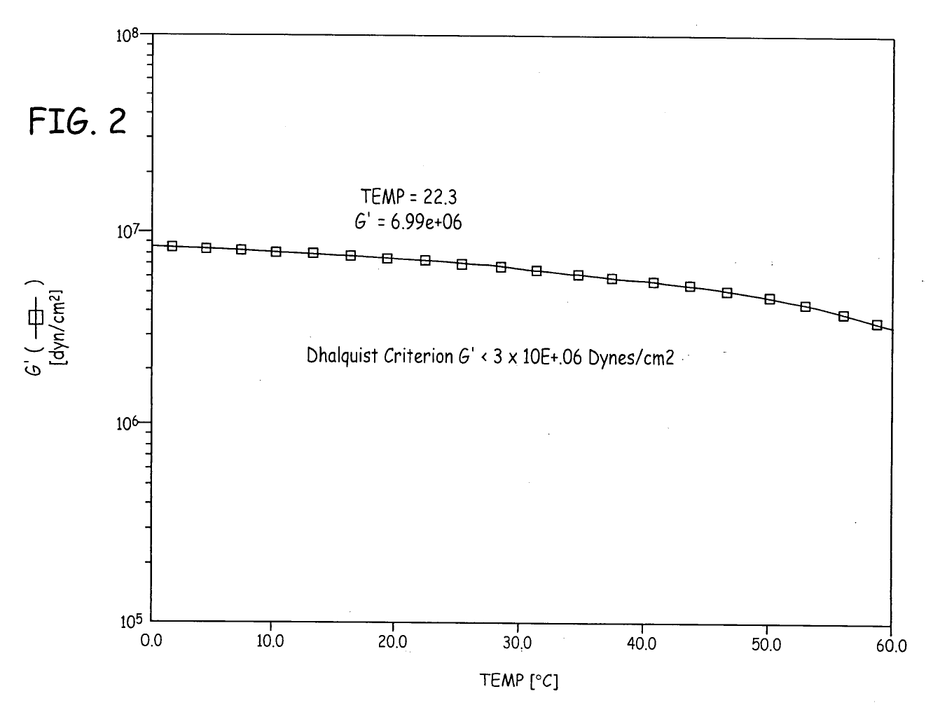

The elastomeric compositions, in accordance with one embodiment of the present invention, have a shear storage modulus (G′) of from about 7×10⁷ to about 1.5×10⁶ at 20° C., and from about 2×10⁵ to about 1.5×10⁶ at 40° C. Alternatively, the elastomeric compositions of the invention have a shear storage modulus of greater than about 3×10⁶ dynes/cm² over a temperature range of from about 0° C. to about 60° C. In one aspect, the elastomeric compositions of the invention have a shear storage modulus of from about 9×10⁶ dynes/cm² to about 3×10⁶ dynes/cm² over a temperature range of from about 0° C. to about 60° C. For example, FIG. 2 depicts the shear storage modulus of an elastomeric composition of the invention with a formulation of 53% Vector 6241, a styrenebutadiene-styrene block copolymer (Exxon Mobil Chemical Co.), 30% Penznapp 500, a naphthenic process oil, 16.5% Zonatac 105L, a modified terpene resin and 0.5% Irganox 1010, an antioxidant, having a shear storage modulus of about 6.99×10⁶ dynes/cm² at 22.3° C.

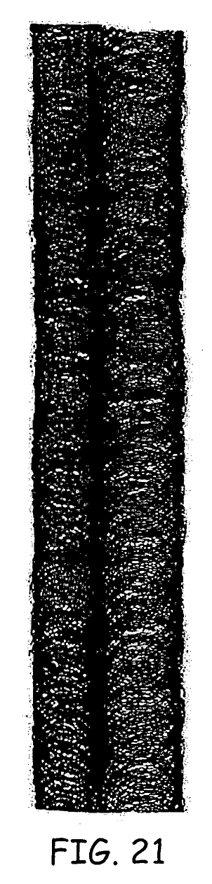

According to one embodiment, the compositions of the present invention are applied using a unique spiral spray method. In accordance with the unique method, known hot melt application equipment having two spray nozzles is used, wherein the two nozzles extrude two filaments of the composition simultaneously such that the filaments overlap and intercross with each other to form a 3D interlocking web as depicted in FIG. 21. Alternatively, the unique spiral spray method can be performed using three or more nozzles extruding three or more filaments simultaneously such that the filaments overlap and intercross to create the 3D interlocking web. In a further alternative, the spiral spray method can be performed using as many nozzles as possible that can still successfully extrude filaments such that they overlap and intercross to create the 3D web. In yet another alternative, the spiral spray method is performed using one nozzle that is used to apply filament in a repetitive fashion to allow the filament to overlap to form the 3D web.

In accordance with an alternative embodiment of the present invention, the elastomeric compositions provided by the present invention can be applied to nonwovens by any known method. That is, the elastomeric compositions of the invention can be coated, extruded, sprayed, blown, etc. onto a nonwoven surface.

According to one embodiment, a composition of the present invention is applied to a substrate to create a laminate. Alternatively, the composition is disposed between two substrates to create a laminate. In one aspect of the present invention, the composition, upon application, tends to penetrate into a porous substrate, forming a network or interlocking matrix that bonds the composition to the substrate. According to one embodiment, the elastomeric composition penetrates only minimally into the porous fiber structure of the nonwoven, generally on the order of a few microns. Not to be limited by theory, it is believed that this unique aspect of the elastomeric composition helps to provide the elasticity of the formed article. In contrast, most adhesives in the existing technology penetrate deeper into the nonwoven than a few microns, thus resulting in a thinner film and thus a weaker elastic bond.

According to one embodiment, the spiral spray method creates a 3D interlocking web that exhibits a complex lattice or network of filaments of the present composition that are interlaced or intertwined in both an overlapping and intercrossing fashion. The advantage of the 3D interlock web is that it can be elongated in both directions and can confer the same characteristics on a laminate of which the web is a component. That is, the web can be elongated in the “machine direction” (the length of the web in the direction in which it was produced) and can also be elongated in the “transverse direction” (the direction generally perpendicular to the machine direction). According to one embodiment, the more filaments that are implemented into the web, the greater the similarity between the elongation characteristics in the machine direction and the elongation characteristics in the transverse direction. That is, the greater the number of filaments, the more likely the elongation distances in both directions are substantially similar.

According to one embodiment, the elastomeric compositions of the present invention can be extended in either the machine direction or the transverse direction at least 50% from their untensioned state and return to at least 70% of their untensioned state after tension is removed. In further embodiments, the elastomeric compositions can be extended in either direction at least 50% from their untensioned state and will return to at least 80% of their untensioned state after tension is removed. In still another embodiment, the elastomeric compositions can be extended in either direction at least 50% from their untensioned state and will return to at least 90% of their untensioned state after tension is removed. In accordance with an additional aspect, the compositions of the present invention can be extended at least 100% and even at least 150% and will return to the percentages of their untensioned state as above.

According to one embodiment, the elastomeric compositions of the invention exhibit low percent set relative to compositions according to existing technology. The terms “set” or “percent set” (% set) are recognized in the art and refer to the percent deformation of an elastomeric material measured while the material is in a relaxed condition for a specified period of time (i.e., 60 seconds for the Test Methods described herein) after the material was released from a specified elongation without allowing the material to snap back completely. The percent set is expressed as [(zero load extension after one cycle—initial sample gauge length of cycle 1)/(initial sample gauge length of cycle 1)]×100. Zero load extension refers to the distance between the jaws at the beginning of the second cycle before a load is registered by the tensile testing equipment. According to one aspect of the invention, the elastomeric compositions exhibit no greater than 50% set. Alternatively, the compositions exhibit no greater than 30% set. In a further alternative, the compositions exhibit no greater than 20% set. For example, the composition in accordance with one aspect of the invention exhibits about 20% set.

The elastomeric compositions of the invention are capable of imparting elasticity to nonwoven webs in general and to inelastic nonwoven webs in particular. The nonwoven web can include synthetic polymer fibers of, e.g., polyester, polyolefin (e.g., polypropylene, polyethylene, and copolymers of polyolefins and polyesters), polyamide, polyurethane, polyacrylonitrile, and combinations thereof including copolymers thereof, bicomponent (e.g., sheath core) fibers and combinations thereof. Nonwoven webs can be formed using a variety of methods including, e.g., air-laying, wet laying, garneting and carding, and melt blown and spun bond techniques.

The invention will now be described further by way of the following examples. All parts, ratios, percents and amounts stated in the Examples are by weight unless otherwise specified.

### EXAMPLE 1

Methods and Materials

An elastomer composition was prepared by combining 53% Vector 6241 styrene-butadiene-styrene block copolymer (ExxonMobil Chemical Co.), 30% Penznapp 500 naphthenic oil, 16.5% Zonatac-105L modified terpene resin and 0.5% Irganox 1010 antioxidant (Ciba-Geigy) with mixing. The composition was then slot-coated between two spunbond nonwovens.

In a second aspect of this example, the above elastomer composition was also prepared as above and then spiral sprayed into a 3D web of the present invention.

The laminate including the composition was tested both for 100% stretch and 150% stretch as described above. That is, the laminate is stretched to a specified elongation (as set forth in the figures herein) without being allowed to snap back completely. Subsequently, the percent deformation of the material is measured while the material is in a relaxed condition for 60 seconds.

The 3D web of the composition was tested for 140% stretch as described above in both the machine and transverse directions.

Further, the composition was tested for shear storage modulus as described above.

Results

The composition exhibited a viscosity of 117,000 mPa.s at 275° F., 45,250 mPa.s at 300° F., 30,000 mPa.s at 325° F. and 17,500 mPa.s at 350° F.

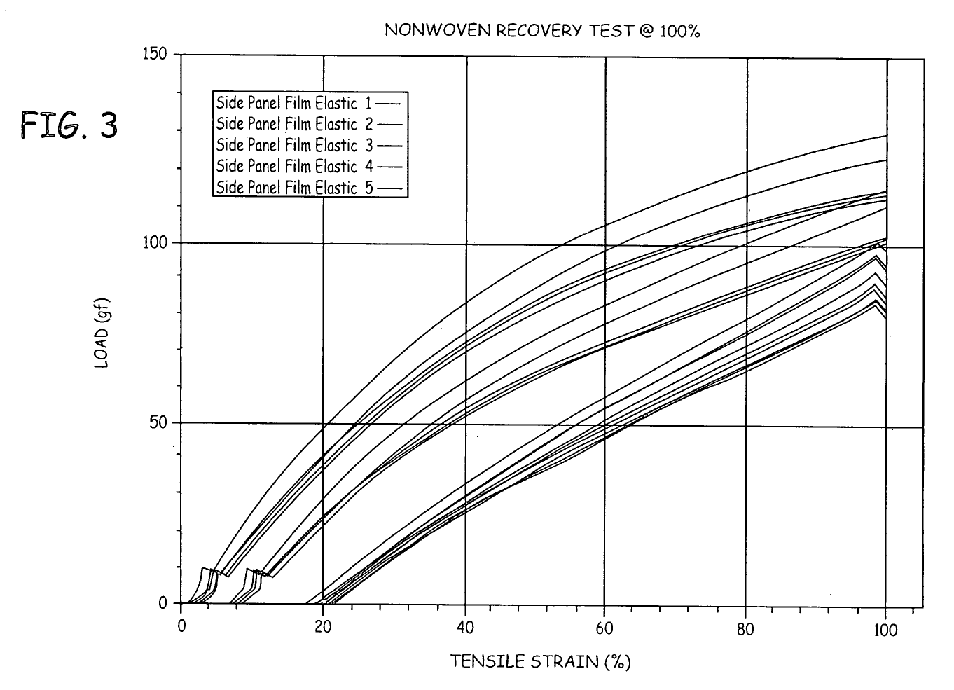

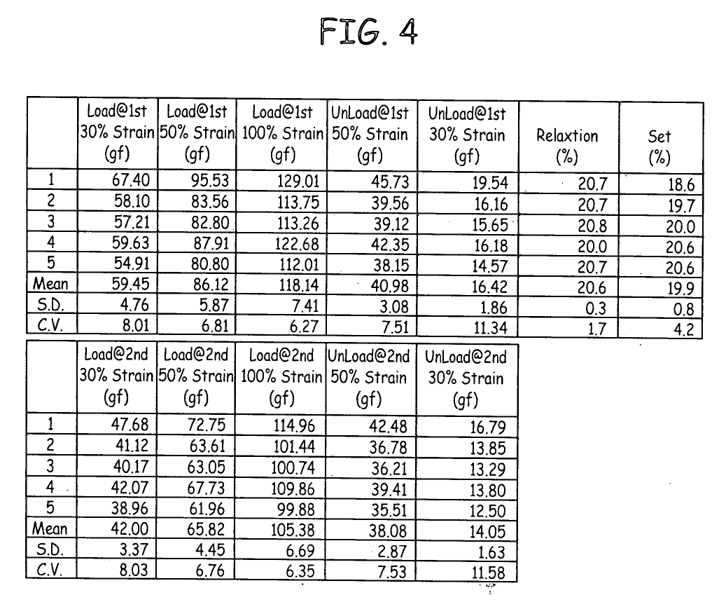

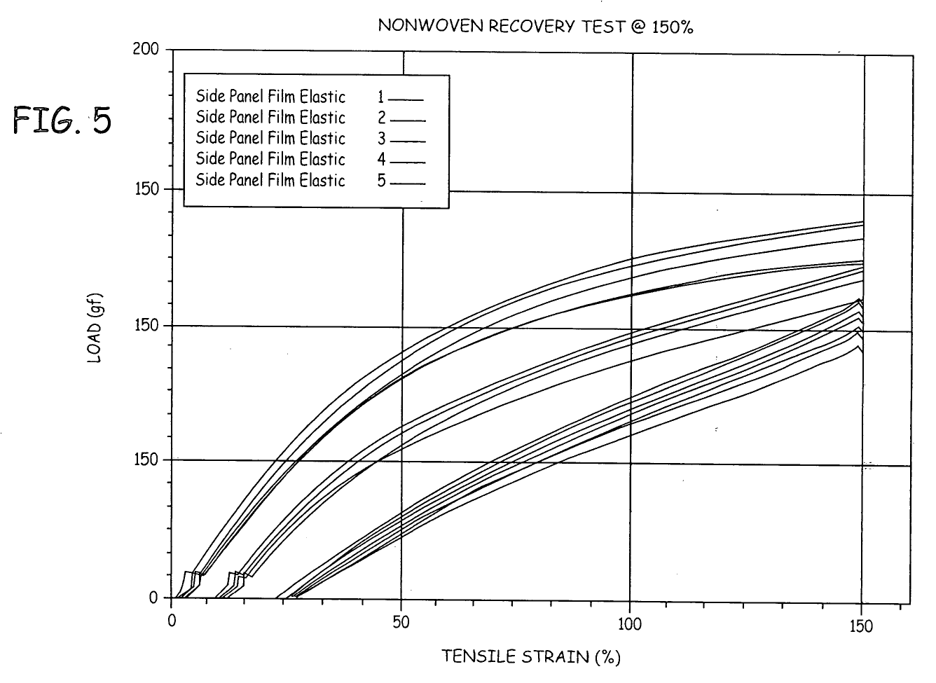

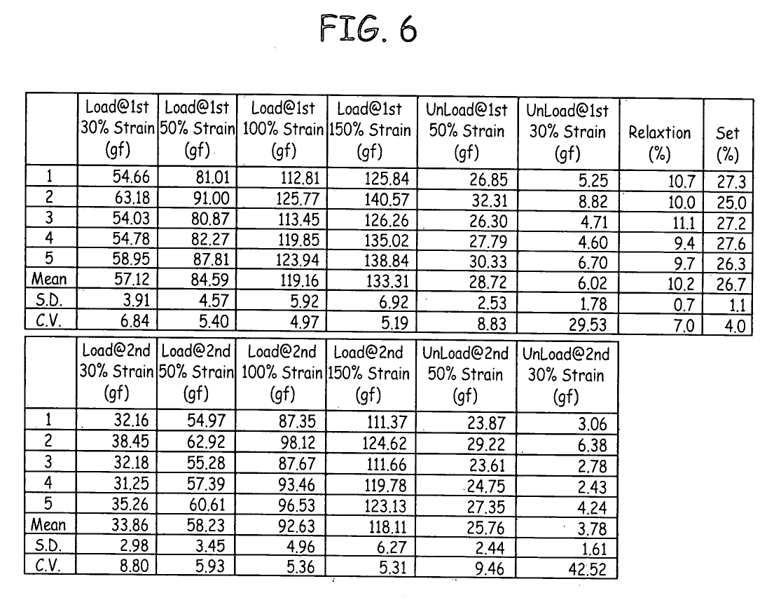

Further results relating to the laminate are set forth in FIGS. 3 through 6. In the graphs, the x axis represents load values in grams force (gf) and the y axis represents percentage stretch in terms of tensile strength. FIGS. 3 and 4 present the results for the 100% stretch testing of the laminate, while FIGS. 5 and 6 present the results for the 150% stretch testing.

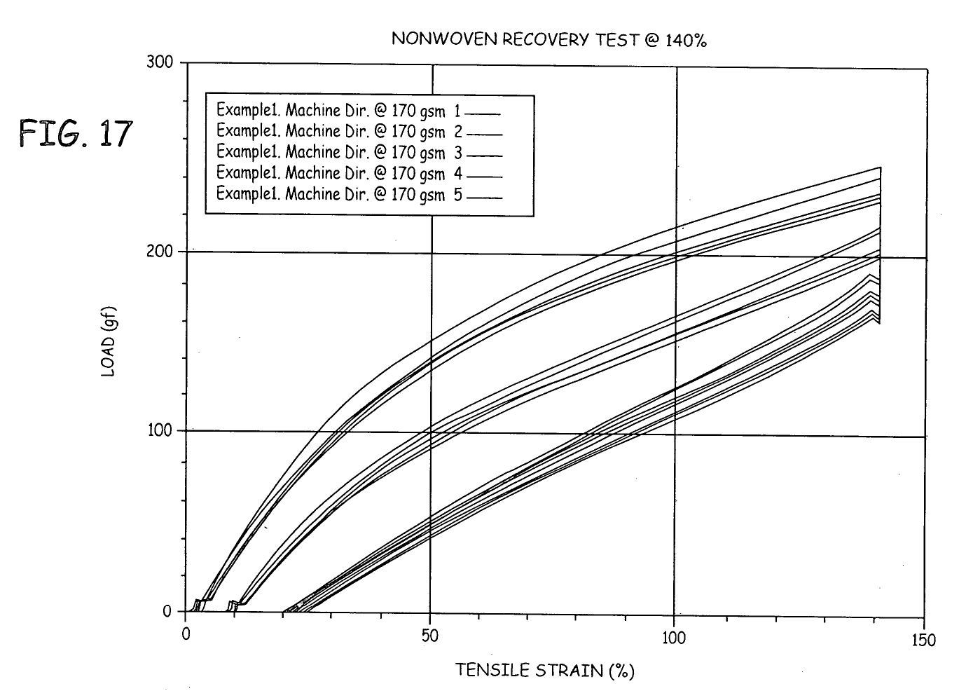

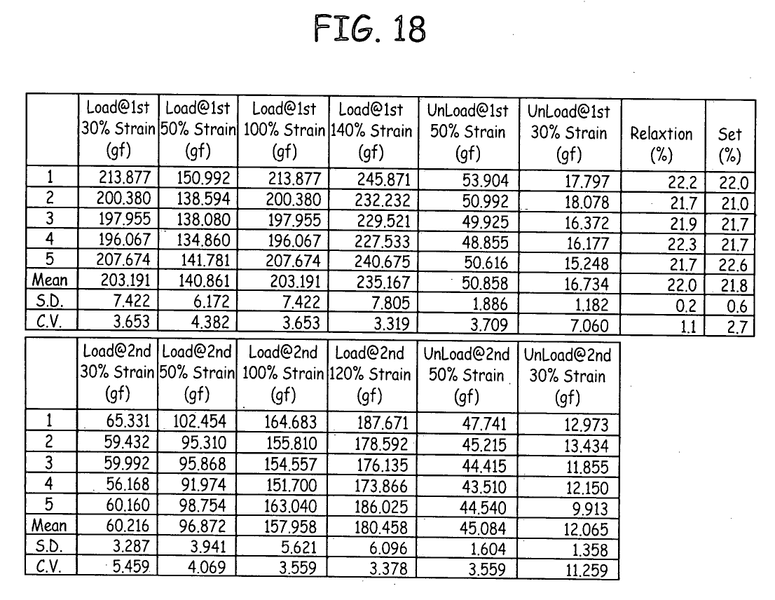

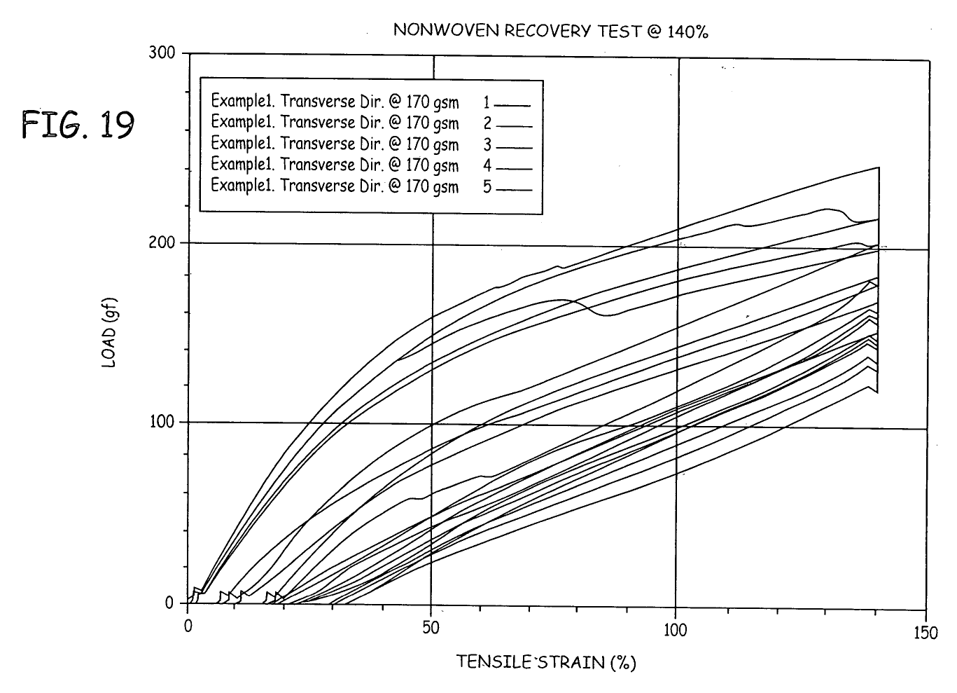

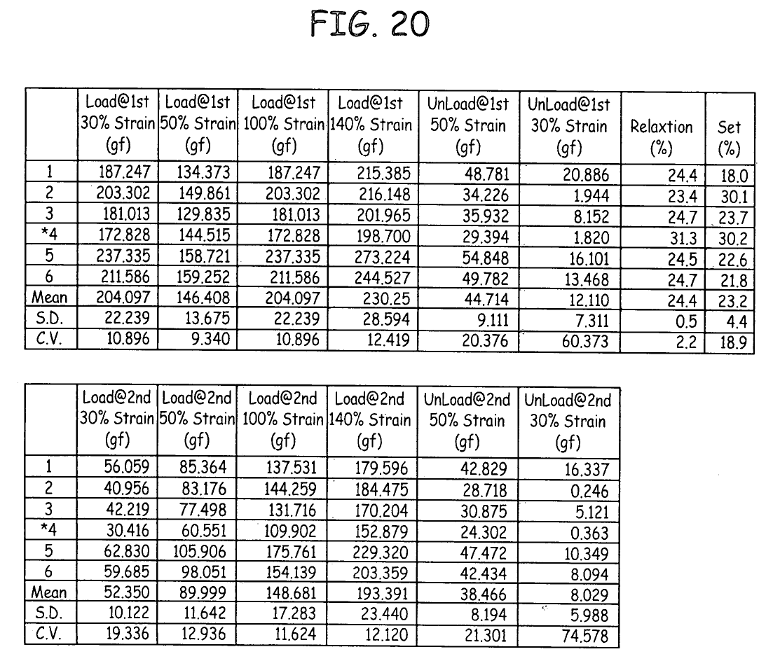

Further results relating to the 3D web are set forth in FIGS. 17 through 20. In the graphs, the x axis represents load values in grams force (gf) and the y axis represents percentage stretch in terms of tensile strength. FIGS. 17 and 18 present the results for the 140% stretch testing of the 3D web in the machine direction, while FIGS. 19 and 20 present the results for the 140% stretch testing in the transverse direction.

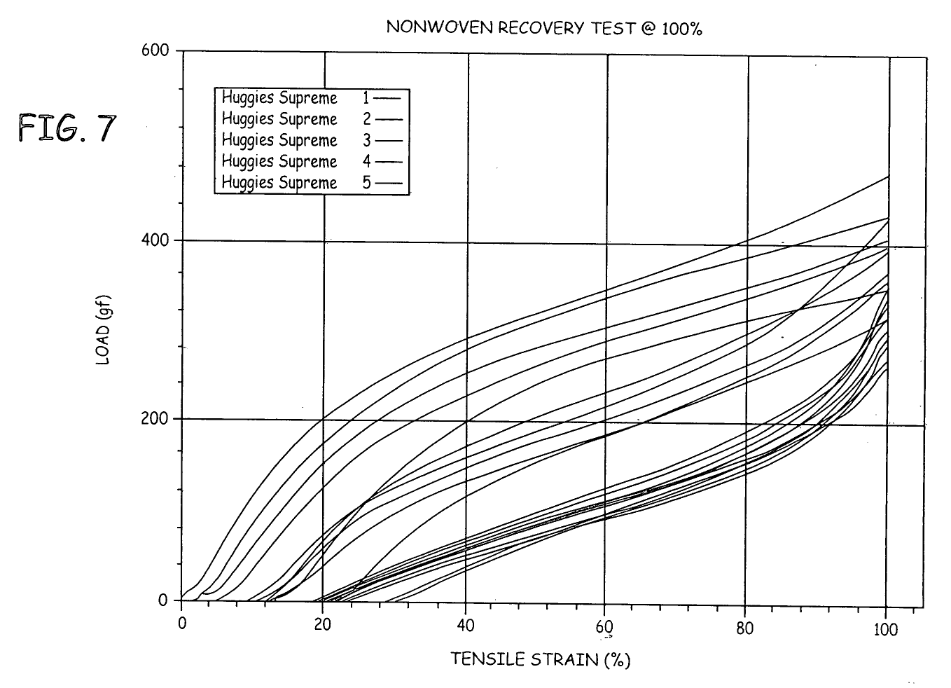

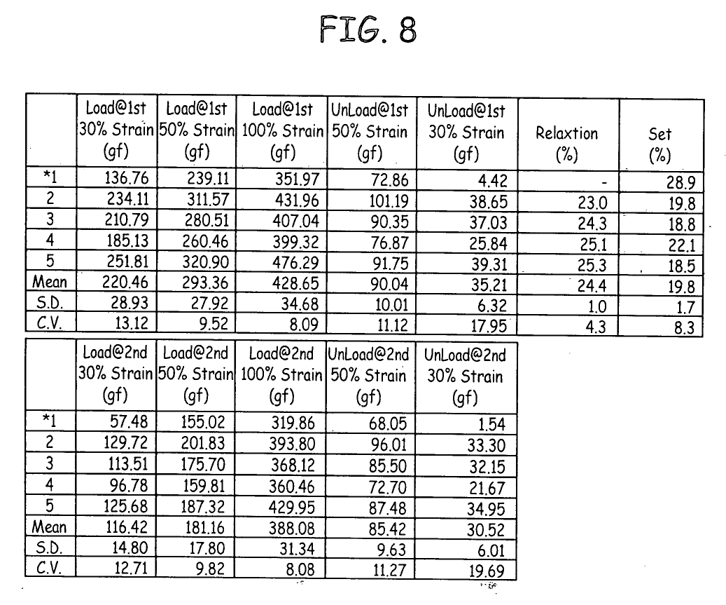

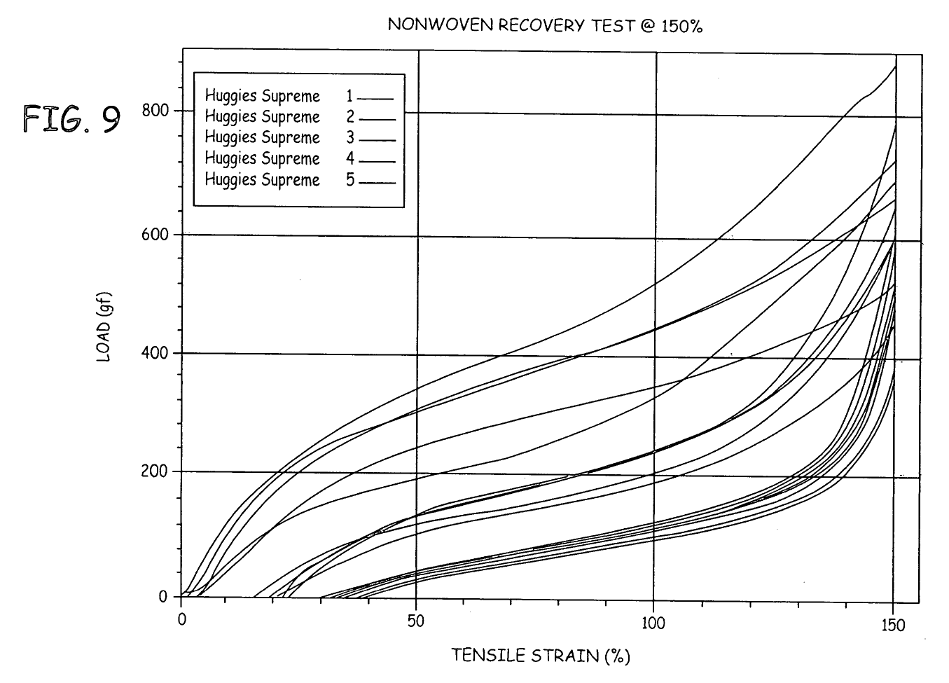

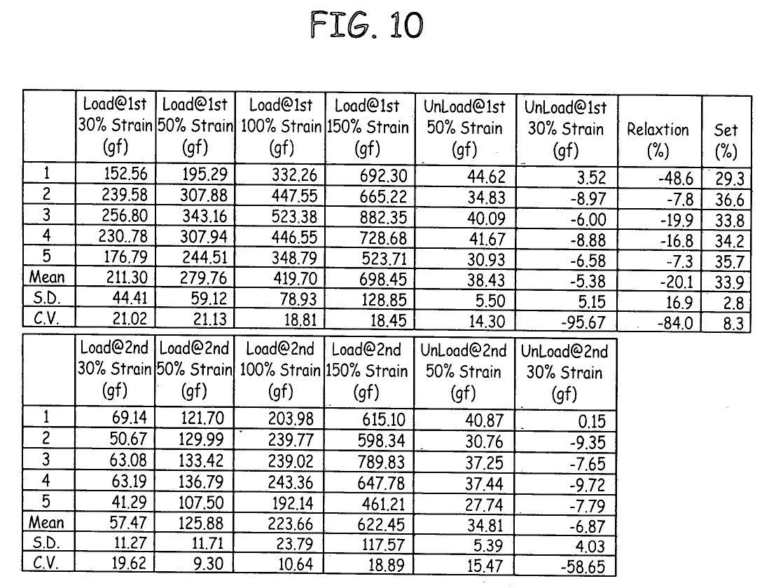

FIGS. 7 through 10 are graphical and tabular representations based upon the commercially available “HUGGIES SUPREME™”. The diaper material was tested both for 100% stretch and 150% stretch as described above.

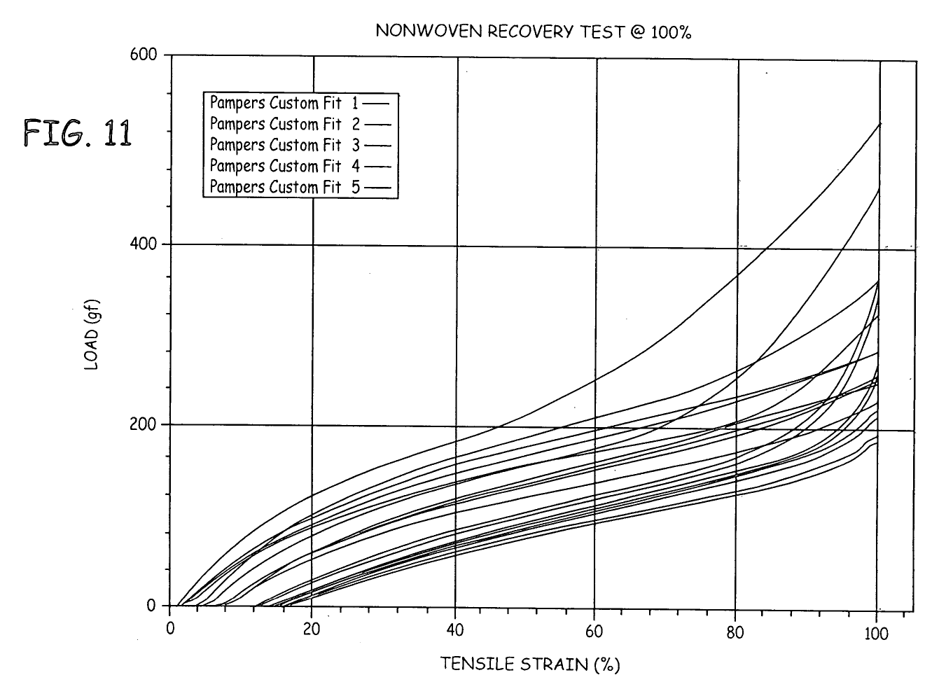

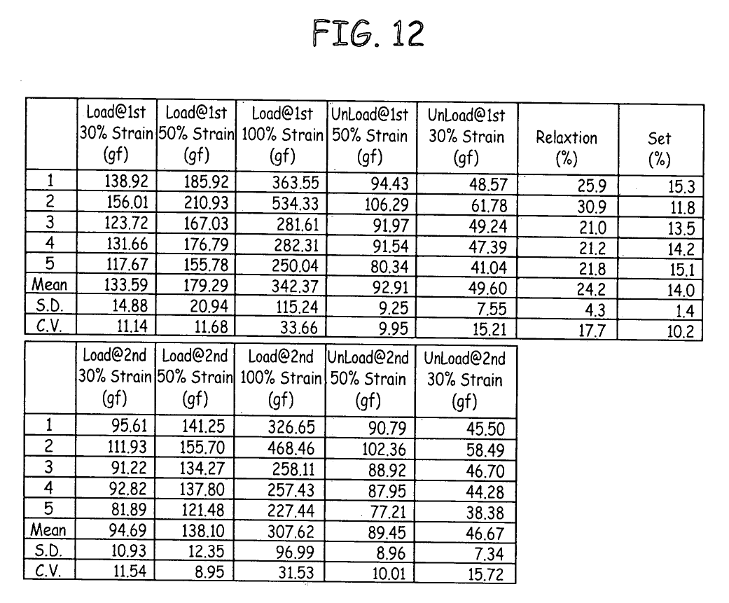

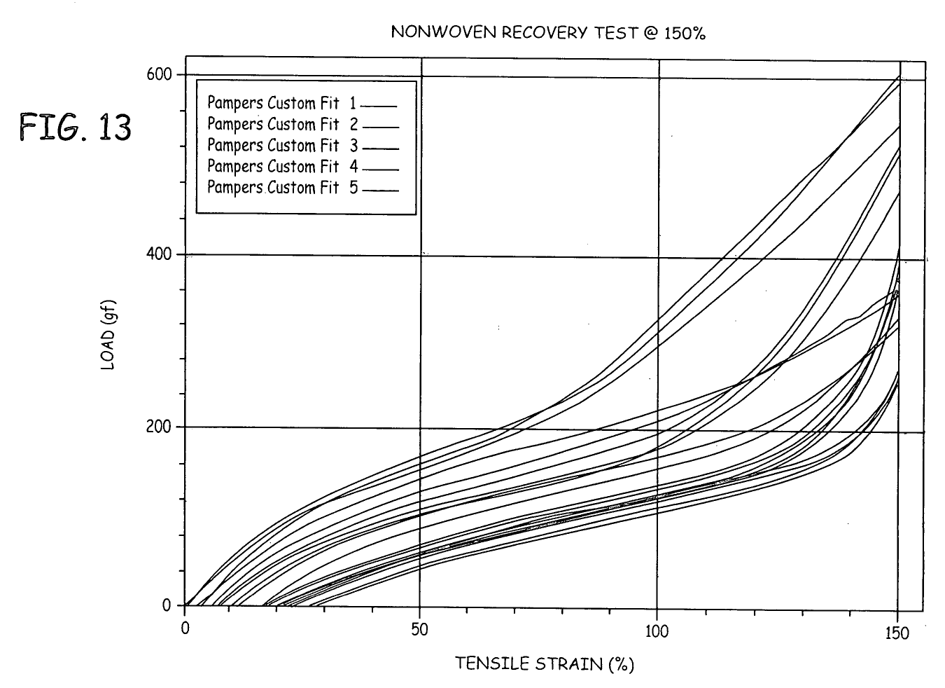

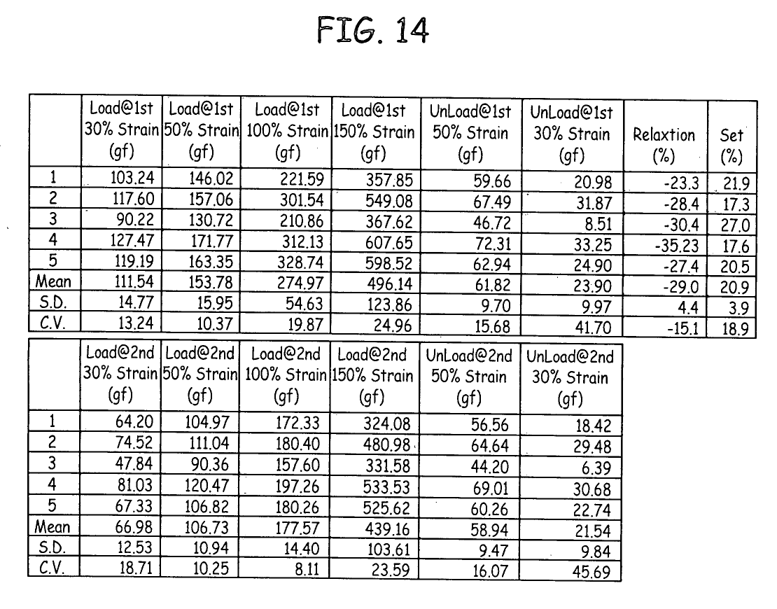

FIGS. 11 through 14 are graphical and tabular representations based upon the commercially available “PAMPERS CUSTOM FIT™”. The diaper material was tested both for 100% stretch and 150% stretch as described above.

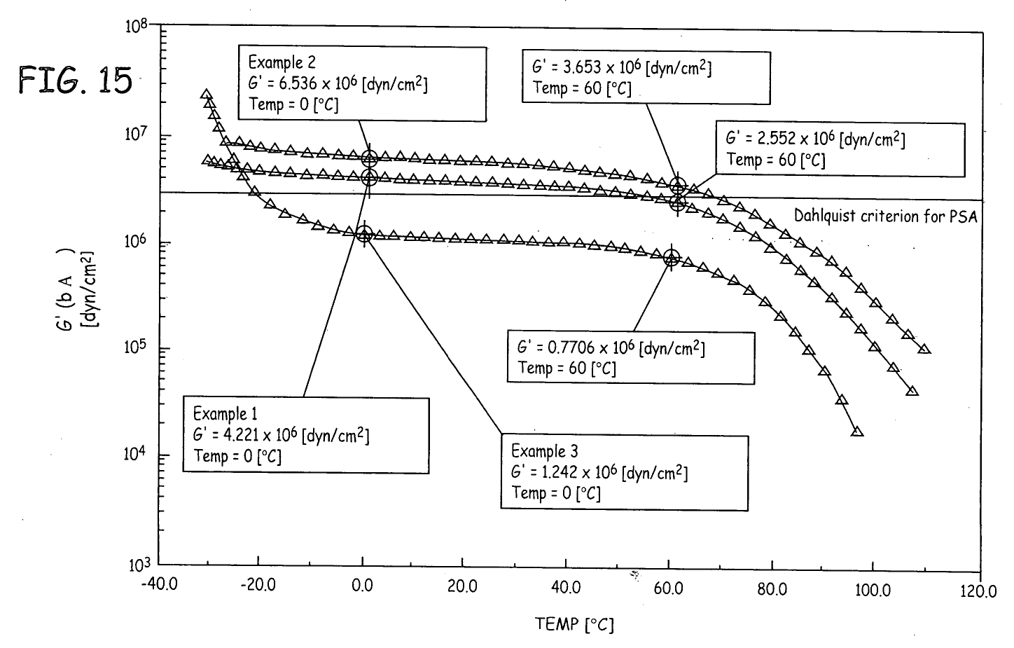

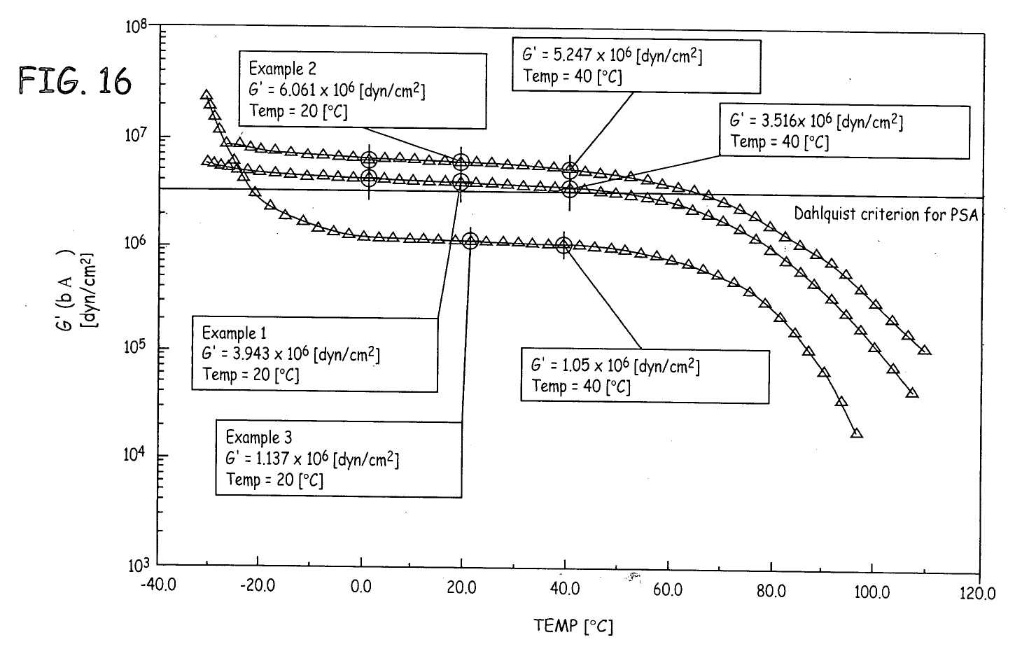

FIG. 15 sets forth the shear storage modulus of the composition (identified in the graph as “Example 1”) along a range of temperatures, and specifically identifies the shear storage modulus values of the composition at 0° C. and at 60° C. FIG. 16 specifically identifies the shear storage modulus values of the composition at 20° C. and at 40° C.

Analysis

The results depicted in FIGS. 3 through 14 demonstrate that the elastomeric compositions of the invention have tensile strength (in view of relaxation percentage and set percentage) of at least equivalent, or better than, those materials incorporated into commercially available diaper materials.

### EXAMPLE 2

Methods and Materials

An elastomer composition was prepared by combining 62% Vector 6241 styrene-butadiene-styrene block copolymer (ExxonMobil Chemical Co.), 21% Penznapp 500 naphthenic oil, 16% Zonatac-105L modified terpene resin, and 0.5% Irganox 1010 antioxidant (Ciba-Geigy), with mixing.

The composition was tested for shear storage modulus as described above.

Results

The composition exhibited a viscosity of 780,000 mPa.s at 275° F., 268,000 mPa.s at 300° F., 108,000 mPa.s at 325° F. and 54,000 mPa.s at 350° F.

FIG. 15 sets forth the shear storage modulus of the composition (identified in the graph as “Example 2”) along a range of temperatures, and specifically identifies the shear storage modulus values of the composition at 0° C. and at 60° C. FIG. 16 specifically identifies the shear storage modulus values of the composition at 20° C. and at 40° C.

### EXAMPLE 3

Methods and Materials

An elastomer composition was prepared by combining 39% Vector 6241 styrene-butadiene-styrene block copolymer (ExxonMobil Chemical Co.), 31.7% Penznapp 500 naphthenic oil, 28.7% Zonatac-105L modified terpene resin and 0.5% Irganox 1010 antioxidant (Ciba-Geigy) with mixing.

The composition was tested for shear storage modulus as described above.

Results

The composition exhibited a viscosity of 28,300 mPa.s at 275° F., 13,700 mPa.s at 300° F., 7720 mPa.s at 325° F. and 4960 mPa.s at 350° F.

FIG. 15 sets forth the shear storage modulus of the composition (identified in the graph as “Example 3”) along a range of temperatures, and specifically identifies the shear storage modulus values of the composition at 0° C. and at 60° C. FIG. 16 specifically identifies the shear storage modulus values of the composition at 20° C. and at 40° C.

Other embodiments are within the claims. One having ordinary skill in the art will appreciate further features and advantages of the invention based on the above-described embodiments. Accordingly, the invention is not to be limited by what has been particularly shown and described, except as indicated by the appended claims. All publications and references cited herein, including those in the background section, are expressly incorporated herein by reference in their entirety.

What is claimed is:

1. A hot melt thermoplastic elastomer composition comprising:
from about 35% by weight to about 70% by weight of a block copolymer formed from at least two blocks, a first block comprising at least one monoalkenyl arene and a second block comprising at least one conjugated diene;
from about 5% by weight to about 30% by weight of a tackifying agent; and
from about 15% by weight to about 45% by weight of a plasticizer,
wherein the composition has a viscosity of from about 75,000 mPa.s to about 5,000 mPa.s at a temperature of about 350° F.

2. The composition of claim 1, wherein said monoalkenyl arene is styrene.

3. The composition of claim 1, wherein said conjugated diene is butadiene or isoprene.

4. The composition of claim 1, wherein said monoalkenyl arene is styrene and said conjugated diene is butadiene.

5. The composition of claim 1, wherein said monoalkenyl arene is styrene and said conjugated diene is isoprene.

6. The composition of claim 1, wherein said composition exhibits a shear storage modulus (G′) of from 7×10⁷ to 1.5×10⁶ at 20° C., and from 2×10⁵ to 1.5×10⁶ at 40° C.

7. The composition of claim 1, wherein said composition is not a pressure sensitive adhesive.

8. The composition of claim 1, wherein said composition has a shear storage modulus of greater than about 3×10⁶ dynes/cm² over a temperature range of between about 0° C. and about 60° C.

9. The composition of claim 8, wherein said shear storage modulus is between about 9×10⁶ dynes/cm² and about 3×10⁶ dynes/cm² over a temperature range of between about 0° C. and about 60° C.

10. The composition of claim 1, wherein said composition has a shear storage modulus of less than about 3×10⁶ dynes/cm² over a temperature range of between about 0° C. and about 60° C.

11. The composition of claim 1, wherein said composition exhibits no greater than 50% set.

12. A laminate comprising
a first substrate; and
a hot melt thermoplastic elastomer composition associated with the substrate, the composition having a viscosity of from about 75,000 mPa.s to about 5,000 mPa.s at a temperature of about 350° F., the composition comprising:
from about 35% by weight to about 70% by weight of a block copolymer formed from at least two blocks;
from about 5% by weight to about 30% by weight of a tackifying agent; and
from about 15% by weight to about 45% by weight of a plasticizer.

13. The laminate of claim 12, wherein said laminate is used in side panels, waist bands, cuffs, topsheets, backsheets, bandages, wraps or wound dressings.

14. The laminate of claim 12, wherein said laminate is disposed upon an absorbent material, such that an absorbent article is formed.

15. The laminate of claim 14, wherein said article is pull-on diapers, training pants, disposable diapers with fasteners, feminine napkins, pantiliners or incontinence garments.

16. The laminate of claim 12 further comprising a second substrate associated with the composition.

17. A method of extruding a hot melt thermoplastic composition comprising:
providing a hot melt thermoplastic elastomer composition having a viscosity of from about 75,000 mPa.s to about 5,000 mPa.s at a temperature of about 350° F., the composition comprising:
from about 35% by weight to about 70% by weight of a block copolymer formed from at least two blocks;
from about 5% by weight to about 30% by weight of a tackifying agent; and
from about 15% by weight to about 45% by weight of a plasticizer; and
extruding the composition with a spiral spraying action such that filaments of the composition overlap and intercross with each other to create a three-dimensional web.

18. The method of claim 17 wherein the extruding the composition with a spiral spraying action is performed with at least one spray nozzle.

19. An interlocking hot melt thermoplastic elastomer web comprising overlapping and intercrossing filaments of a hot melt thermoplastic elastomer composition having a viscosity of from about 75,000 mPa.s to about 5,000 mPa.s at a temperature of about 350° F., the composition comprising:
(a) from about 35% by weight to about 70% by weight of a block copolymer formed from at least two blocks;
(b) from about 5% by weight to about 30% by weight of a tackifying agent; and
(c) from about 15% by weight to about 45% by weight of a plasticizer,
wherein the web can be elongated in both a machine direction and a transverse direction.

20. The web of claim 19 wherein the web can be elongated at least 50% from an untensioned state and return to at least 70% of the untensioned state after tension is removed.
